(19) United States
(12) Patent Application Publication
(10) Pub. No.: US 2013/0323437 A1
(43) Pub. Date: Dec. 5, 2013

(54) PRESSURE-SENSITIVE ADHESIVE SHEET FOR OPTICAL USE

(71) Applicant: NITTO DENKO CORPORATION, Osaka (JP)

(72) Inventors: Tomohide Banba, Ibaraki-shi (JP); Hiroaki Kishioka, Ibaraki-shi (JP); Takahiro Nonaka, Ibaraki-shi (JP); Masatomo Natsui, Ibaraki-shi (JP); Hiroaki Fumoto, Ibaraki-shi (JP); Shou Takarada, Ibaraki-shi (JP); Takashi Suzuki, Ibaraki-shi (JP)

(73) Assignee: NITTO DENKO CORPORATION, Ibaraki-shi (JP)

(21) Appl. No.: 13/962,086

(22) Filed: Aug. 8, 2013

Related U.S. Application Data
(62) Division of application No. 13/378,958, filed on Dec. 16, 2011.

(30) Foreign Application Priority Data
Jun. 18, 2009 (JP) 2009-145392

(51) Int. Cl. C09J 133/14; C09J 133/08

(52) U.S. Cl. CPC C09J 133/14; C09J 133/08
USPC 428/1.54; 428/156; 526/320; 526/318.42; 526/263

(57) ABSTRACT

Provided is a pressure-sensitive adhesive sheet for optical use which less suffers from a misoperation-causing change in capacitance upon application to an optical member.

The pressure-sensitive adhesive sheet for optical use includes a pressure-sensitive adhesive layer and has a dielectric constant of from 2 to 8 at a frequency of 1 MHz and a dielectric loss tangent of more than 0 and 0.2 or less at a frequency of 1 MHz. The pressure-sensitive adhesive sheet for optical use preferably has a dielectric constant at a frequency of 1.0×10⁶ Hz being 60% or more of that at a frequency of 1.0×10⁴ Hz. In addition, the pressure-sensitive adhesive sheet for optical use preferably has an absolute value of difference between the dielectric loss tangent at a frequency of 1.0×10⁶ Hz and that at a frequency of 1.0×10⁴ Hz of 0.15 or less.

### TECHNICAL FIELD

The present invention relates to a pressure-sensitive adhesive sheet for optical use.

### BACKGROUND ART

Various fields have recently widely employed display devices, such as liquid crystal displays (LCDs), as well as input devices, such as touch panels, for use in combination with the display devices. Typically in manufacture of these display devices and input devices, pressure-sensitive adhesive sheets are used in applications of bonding an optical member (see, for example, PTL 1).

As trends in image display systems, those of touch panel system intensively receive attention, and, among others, touch panels of capacitance-operated system (capacitive touch panels) become popular. In such capacitive touch panels, a pressure-sensitive adhesive layer (layer formed from a pressure-sensitive adhesive) is used not only for bonding a transparent member but also for serving as an insulating layer. Capacitive touch panels have a mechanism in which, with the touch typically of a finger on the touch panel, an output signal at that position changes, and sensing occurs when the change of the signal rises above a certain threshold level. Such a capacitive touch panel, unless having a capacitance stably maintained at a constant level, may cause a misoperation.

### CITATION LIST

### Patent Literature

PTL 1: Japanese Unexamined Patent Application Publication (JP-A) No. 2002-363523

### SUMMARY OF INVENTION

### Technical Problem

However, capacitive touch panels using customary pressure-sensitive adhesive layers may suffer from malfunctions due probably to the pressure-sensitive adhesive layers in some cases. In particular, they may suffer from malfunctions upon large signal change due to noise from outside sources such as display devices.

Accordingly, an object of the present invention is to provide a pressure-sensitive adhesive sheet for optical use, which sheet does not adversely affect the functions and properties of an optical member even when it is applied to the optical member. Another object of the present invention is to provide a pressure-sensitive adhesive sheet for optical use, which sheet, even when used particularly for bonding a transparent member in a capacitive touch panel, does not cause occurrence of misoperation of the assembled touch panel.

### Solution to Problem

After intensive investigations to achieve the objects, the present inventors have found that a pressure-sensitive adhesive sheet for optical use having a dielectric constant (relative) within a specific range at a frequency of 1 MHz and a dielectric loss tangent within a specific range at a frequency of 1 MHz does not cause, upon use, misoperation of an optical member and does not adversely affect the sensitivity required of the optical member. They also have found that the pressure-sensitive adhesive sheet, particularly when used in a capacitive touch panel, does not cause misoperation of the capacitive touch panel and does not adversely affect the sensitivity thereof. The present invention has been made based on these findings.

Specifically, the present invention provides, in one aspect, a pressure-sensitive adhesive sheet for optical use, which includes a pressure-sensitive adhesive layer. The pressure-sensitive adhesive sheet has a dielectric constant (relative) of from 2 to 8 at a frequency of 1 MHz and a dielectric loss tangent of more than 0 and 0.2 or less at a frequency of 1 MHz.

The present invention provides, in an embodiment, the pressure-sensitive adhesive sheet for optical use in which the pressure-sensitive adhesive sheet has a dielectric constant (relative) at a frequency of 1.0×10⁶ Hz being 60% or more of a dielectric constant (relative) at a frequency of 1.0×10⁴ Hz.

In another embodiment, the present invention provides the pressure-sensitive adhesive sheet for optical use in which the pressure-sensitive adhesive sheet has an absolute value of difference between a dielectric loss tangent at a frequency of 1.0×10⁶ Hz and a dielectric loss tangent at a frequency of 1.0×10⁴ Hz of 0.15 or less.

In yet another embodiment, the present invention provides the pressure-sensitive adhesive sheet for optical use in which the pressure-sensitive adhesive sheet has a thickness precision of 10% or less.

In still another embodiment, the present invention provides the pressure-sensitive adhesive sheet for optical use in which the pressure-sensitive adhesive layer is an acrylic pressure-sensitive adhesive layer.

The present invention provides, in another embodiment, the pressure-sensitive adhesive sheet for optical use in which the acrylic pressure-sensitive adhesive layer includes, as a base polymer, an acrylic polymer derived from an alkyl (meth)acrylate and/or an alkoxy alkyl (meth)acrylate as an essential monomer component, the alkyl (meth)acrylate having a linear or branched chain alkyl group containing 1 to 14 carbon atoms.

The present invention provides, in a further embodiment, the pressure-sensitive adhesive sheet for optical use in which the acrylic pressure-sensitive adhesive layer has been formed from a pressure-sensitive adhesive composition prepared by an ultraviolet-initiated polymerization process through ultraviolet irradiation.

The present invention provides, in still another embodiment, the pressure-sensitive adhesive sheet for optical use, which is used for bonding a member constituting a touch panel.

The present invention provides, in another embodiment, the pressure-sensitive adhesive sheet for optical use in which the touch panel is of capacitance-operated system.

The present invention provides, in another aspect, a liquid crystal display device or input device using the pressure-sensitive adhesive sheet for optical use.

### Advantageous Effects of Invention

The pressure-sensitive adhesive sheet for optical use according to the present invention, as having the configuration, does not adversely affect the functions and properties of an optical member even upon application to the optical member. In particular, the pressure-sensitive adhesive sheet, even when used for bonding of a transparent member in a capacitive touch panel, prevents the occurrence of a misoperation of the resulting assembled touch panel.

### BRIEF DESCRIPTION OF DRAWINGS

FIG. 1 is a schematic diagram illustrating an exemplary capacitive touch panel formed by bonding a member using the pressure-sensitive adhesive sheet for optical use according to the present invention.

### DESCRIPTION OF EMBODIMENTS

A pressure-sensitive adhesive sheet for optical use according to the present invention has a dielectric constant (relative) of from 2 to 8 at a frequency of 1 MHz and a dielectric loss tangent of more than 0 and 0.2 or less at a frequency of 1 MHz. The pressure-sensitive adhesive sheet for optical use according to the present invention is used not only for bonding an optical member but also for serving as an insulator.

The pressure-sensitive adhesive sheet for optical use according to the present invention has at least a pressure-sensitive adhesive layer and includes both a tape-like one and a sheet-like one. The pressure-sensitive adhesive sheet for optical use according to the present invention may be of a base-less type having no base or carrier (base layer) or of a base-supported type having a base (base layer). The pressure-sensitive adhesive sheet may be a single-coated pressure-sensitive adhesive sheet being tacky in only one side, or may be a double-coated pressure-sensitive adhesive sheet being tacky in both sides. The pressure-sensitive adhesive layer(s) providing an adhesive face(s) may have a single-layer structure or a multilayer structure. As used herein the term “base (base layer)” does not include a release liner (separator) which will be removed upon use of the pressure-sensitive adhesive sheet.

From the viewpoint of not adversely affecting the functions and properties of an optical member upon application thereto, and, from the viewpoint of providing satisfactory sensing sensitivity and stability upon application particularly to a capacitive touch panel, the pressure-sensitive adhesive sheet for optical use according to the present invention has a dielectric constant (relative) of from 2 to 8 at a frequency of 1 MHz, and preferably has a dielectric constant (relative) of from 2.5 to 6.5 at a frequency of 1 MHz. For example, upon application to a capacitive touch panel, the pressure-sensitive adhesive sheet for optical use according to the present invention, if having a dielectric constant (relative) of less than 2 at a frequency of 1 MHz, may cause an excessively low capacitance necessary for the sensing of the touch panel, may thereby become more susceptible to a noise signal and may have a lower signal-to-noise ratio in sensing, and this may often cause a misoperation, thus being undesirable. In contrast, the pressure-sensitive adhesive sheet, if having a dielectric constant of more than 8 at a frequency of 1 MHz, may often suffer from signal time delay due to such an excessively large capacitance and may suffer from an insufficient sensing sensitivity, thus being undesirable.

From the viewpoint of effective utilization of electric energy necessary for touch panel driving particularly upon application to a capacitive touch panel, the pressure-sensitive adhesive sheet for optical use according to the present invention has a dielectric loss tangent of 0.2 or less (e.g., more than 0 and 0.2 or less) at a frequency of 1 MHz, and preferably has a dielectric loss tangent of 0.15 or less (e.g., more than 0 and 0.15 or less) at a frequency of 1 MHz. The pressure-sensitive adhesive sheet, if having a dielectric loss tangent of more than 0.2 at a frequency of 1 MHz, may cause a large loss in electric energy upon application to a capacitive touch panel and may thereby cause a larger electric power consumption necessary for the panel driving, thus being undesirable.

From the viewpoint of touch panel operational stability particularly upon application to a capacitive touch panel, the pressure-sensitive adhesive sheet for optical use according to the present invention preferably has a dielectric constant (relative) at a frequency of 1.0×10⁶ Hz being 60% or more of a dielectric constant (relative) at a frequency of 1.0×10⁴ Hz, and more preferably has a dielectric constant (relative) at a frequency of 1.0×10⁶ Hz being 70% or more of the dielectric constant (relative) at a frequency of 1.0×10⁴ Hz. The pressure-sensitive adhesive sheet, if having a dielectric constant (relative) at a frequency of 1.0×10⁶ Hz being less than 60% of the dielectric constant (relative) at a frequency of 1.0×10⁴ Hz, may have a significantly varying dielectric constant (relative) and a significantly varying capacitance and may thereby suffer from instable sensing to cause a misoperation when a signal in the touch panel has a largely varying frequency due to noise.

From the view point of touch panel operational stability particularly upon application to a capacitive touch panel, the pressure-sensitive adhesive sheet for optical use according to the present invention preferably has an absolute value of difference between a dielectric loss tangent at a frequency of 1.0×10⁶ Hz and a dielectric loss tangent at a frequency of 1.0×10⁴ Hz of 0.15 or less, and more preferably has an absolute value of difference of 0.12 or less between the dielectric loss tangent at a frequency of 1.0×10⁶ Hz and the dielectric loss tangent at a frequency of 1.0×10⁴ Hz. The pressure-sensitive adhesive sheet, if having an absolute value of difference between the dielectric loss tangent at a frequency of 1.0×10⁶ Hz and the dielectric loss tangent at a frequency of 1.0×10⁴ Hz of more than 0.15 and when used typically for a capacitive touch panel, may cause a misoperation due to a large variation in signal frequency.

The dielectric constant (relative) and dielectric loss tangent may be determined in accordance with Japanese Industrial Standards (JIS) K 6911.

From the view point of touch panel operational stability particularly upon application to a capacitive touch panel, the pressure-sensitive adhesive sheet for optical use according to the present invention preferably has a thickness precision (variation in thickness) of 10% or less and more preferably has a thickness precision of 5% or less with respect to a target thickness. The pressure-sensitive adhesive sheet for optical use, if having a thickness precision of more than 10%, may suffer from a change in capacitance. When the sheet is used in a capacitive touch panel, such a change in capacitance may cause a change in output signal to thereby cause a misoperation.

The thickness precision may be determined in the following manner. Five measurement points are defined in a longitudinal direction within an area of 50 mm wide and 75 mm long, and a thickness at each measurement point is measured using a dial gauge with 1/1000 graduations. A value is determined by dividing a difference between a largest thickness and the target thickness by the target thickness and expressing the result in percentage (see following Expression (1)); and another value is determined by dividing a difference between a smallest thickness and the target thickness by the target thickness and expressing the result in percentage (see following Expression (2)). Then, the absolute value of the former and the absolute value of the latter are compared to each other, and a larger one is defined as a thickness precision (%).

[(Largest thickness)−(Target thickness)]/(Target thickness)×100 (1)

[(Smallest thickness)−(Target thickness)]/(Target thickness)×100 (2)

Though not limited, the pressure-sensitive adhesive sheet for optical use according to the present invention preferably has high optical transparency for providing satisfactory visibility. Typically, the pressure-sensitive adhesive sheet preferably has a total luminous transmittance (in accordance with JIS K 7361) of 90% or more at visible light wavelengths. A pressure-sensitive adhesive layer for use in the present invention preferably has a haze (in accordance with JIS K 7136) of typically 5.0% or less and more preferably has a haze of 2.0% or less. The total luminous transmittance and haze may be measured, for example, with a hazemeter (supplied by Murakami Color Research Laboratory, trade name “HM-150”).

### (Pressure-Sensitive Adhesive Layer)

Though not limited, a base polymer in a pressure-sensitive adhesive for constituting the pressure-sensitive adhesive layer of the pressure-sensitive adhesive sheet for optical use may be chosen appropriately from base polymers for use in known pressure-sensitive adhesives (tacky adhesives) such as acrylic pressure-sensitive adhesives, rubber pressure-sensitive adhesives, vinyl alkyl ether pressure-sensitive adhesives, silicone pressure-sensitive adhesives, polyester pressure-sensitive adhesives, polyamide pressure-sensitive adhesives, urethane pressure-sensitive adhesives, fluorine-containing pressure-sensitive adhesives, epoxy pressure-sensitive adhesives, and polyether pressure-sensitive adhesives. Each of different base polymers may be used alone or in combination.

The pressure-sensitive adhesive layer in the pressure-sensitive adhesive sheet for optical use according to the present invention contains a base polymer or polymers in a content of preferably 60 percent by weight or more (e.g., from 60 to 100 percent by weight) and more preferably in a content of from 80 to 100 percent by weight, based on the total weight of the pressure-sensitive adhesive layer.

The base polymer for use herein is preferably any of base polymers in known acrylic pressure-sensitive adhesives and polyether pressure-sensitive adhesives, and, among others, is more preferably any of base polymers in acrylic pressure-sensitive adhesives, from the viewpoints typically of optical transparency, workability, and durability.

Exemplary base polymers in polyether pressure-sensitive adhesives include, but are not limited to, polyoxyalkylene polymers. Of such polyoxyalkylene polymers, those having a constitutional repeating unit represented by following General Formula (1) in a backbone (principal chain) thereof are preferred.

—R¹—O— General Formula (1)

wherein R¹ is an alkylene group.

R¹ is preferably a linear or branched alkylene group containing 1 to 14 carbon atoms and is more preferably one containing 2 to 4 carbon atoms.

Specific examples of the constitutional repeating unit represented by General Formula (I) include —CH₂O—, —CH₂CH₂O—, —CH₂CH(CH₃)O—, —CH₂CH(C₂H₅)O—, —CH₂C(CH₃)₂O—, and —CH₂CH₂CH₂CH₂O—. The polyoxyalkylene polymer may include a constitutional repeating unit of only one type or may include constitutional repeating units of two or more different types in a backbone skeleton thereof. Above all, polymers including —CH₂CH(CH₃)O— as a principal constitutional repeating unit are preferred from the viewpoints of availability and workability. The polymer may contain one or more other constitutional repeating units than oxyalkylene groups in the backbone. In this case, the polymer contains oxyalkylene units in a total content of preferably 80 percent by weight or more, and particularly preferably 90 percent by weight or more.

The polyoxyalkylene polymer(s) may be a linear polymer or a branched polymer, or a mixture of them, but preferably contains a linear polymer in a content of 50 percent by weight or more for providing satisfactory tackiness.

An acrylic polymer as a base polymer of an acrylic pressure-sensitive adhesive may be formed by using an acrylic monomer as an essential monomer component. In the present invention, a (meth)acrylic alkyl ester having a linear or branched-chain alkyl group (hereinafter also simply referred to as “alkyl (meth)acrylate”) and/or a (meth)acrylic alkoxy alkyl ester (alkoxy alkyl (meth)acrylate) is preferably used as the acrylic monomer. As used herein the term “(meth)acryl(ic)” refers to “acryl(ic)” and/or “methacryl(ic)”, and the same is true for other cases.

An alkyl (meth)acrylate having a linear or branched-chain alkyl group, when used as the acrylic monomer in the present invention, may be used alone or in combination with an alkoxy alkyl (meth)acrylate. In the combination use, the ratio between the alkyl (meth)acrylate having a linear or branched-chain alkyl group and the alkoxy alkyl (meth)acrylate is not limited, and the alkyl (meth)acrylate having a linear or branched-chain alkyl group may be present in a larger amount than, or in a smaller amount than, or in an equivalent amount to, the amount of the alkoxy alkyl (meth)acrylate.

Examples of the alkyl (meth)acrylate having a linear or branched-chain alkyl group include, but are not limited to, alkyl (meth)acrylates whose alkyl group has 1 to 20 carbon atoms, such as methyl (meth)acrylate, ethyl (meth)acrylate, propyl (meth)acrylate, isopropyl (meth)acrylate, butyl (meth)acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, and eicosyl (meth)acrylate. Each of such alkyl (meth)acrylates may be used alone or in combination. Among them, alkyl (meth)acrylates whose alkyl group has 1 to 14 carbon atoms are preferred, of which alkyl (meth)acrylates whose alkyl group has 1 to 10 carbon atoms are more preferred.

Examples of the (meth)acrylic alkoxyalkyl esters (alkoxyalkyl (meth)acrylates) include, but are not limited to, 2-methoxyethyl (meth)acrylate, 2-ethoxyethyl (meth)acrylate, methoxytriethylene glycol (meth)acrylate, 3-methoxypropyl (meth)acrylate, 3-ethoxypropyl (meth)acrylate, 4-methoxybutyl (meth)acrylate, and 4-ethoxybutyl (meth)acrylate. Among them, alkoxyalkyl acrylates are preferred, of which 2-methoxyethyl acrylate (2MEA) is particularly preferred. Each of such alkoxyalkyl (meth)acrylates may be used alone or in combination.

From the view point of adhesiveness of the pressure-sensitive adhesive layer, the acrylic polymer may contain the acrylic monomer(s) in a content of 70 percent by weight or more (e.g., from 70 to 100 percent by weight), more preferably 80 percent by weight or more (e.g., from 80 to 100 percent by weight), and furthermore preferably 90 percent by weight or more (e.g., from 90 to 100 percent by weight), based on the total amount of monomer components for the formation of the acrylic polymer.

Monomer components for the formation of the acrylic polymer serving as a base polymer may further contain a copolymerizable monomer component, such as a polar-group-containing monomer, a multifunctional monomer, and/or another copolymerizable monomer, in addition to the acrylic monomer(s) (alkyl (meth)acrylate having a linear or branched-chain alkyl group, as well as an alkoxyalkyl (meth)acrylate).

Exemplary polar-group-containing monomers include carboxyl-containing monomers such as (meth)acrylic acid, itaconic acid, maleic acid, fumaric acid, crotonic acid, and isocrotonic acid, as well as anhydrides of them (e.g., maleic anhydride); hydroxyl-containing monomers including hydroxylalkyl (meth)acrylates such as 2-hydroxyethyl (meth)acrylate, 3-hydroxypropyl (meth)acrylate, 4-hydroxybutyl (meth)acrylate, and 6-hydroxyhexyl (meth)acrylate, as well as vinyl alcohol and allyl alcohol; amido-containing monomers such as (meth)acrylamide, N,N-dimethyl(meth)acrylamide, N-methylol(meth)acrylamide, N-methoxymethyl(meth)acrylamide, N-butoxymethyl(meth)acrylamide, and N-hydroxyethylacrylamide; amino-containing monomers such as aminoethyl (meth)acrylate, dimethylaminoethyl (meth)acrylate, and t-butylaminoethyl (meth)acrylate; glycidyl-containing monomers such as glycidyl (meth)acrylate and methylglycidyl (meth)acrylate; cyano-containing monomers such as acrylonitrile and methacrylonitrile; heterocycle-containing vinyl monomers such as N-vinyl-2-pyrrolidone, (meth)acryloylmorpholine, as well as N-vinylpyridine, N-vinylpiperidone, N-vinylpyrimidine, N-vinylpiperazine, N-vinylpyrrole, N-vinylimidazole, and N-vinyloxazole; sulfo-containing monomers such as sodium vinylsulfonate; phosphate-containing monomers such as 2-hydroxyethylacryloyl phosphate; imido-containing monomers such as cyclohexylmaleimide and isopropylmaleimide; and isocyanate-containing monomers such as 2-methacryloyloxyethyl isocyanate. Each of such polar-group-containing monomers may be used alone or in combination.

Of the polar-group-containing monomers, preferred are carboxyl-containing monomers or acid anhydrides of them, hydroxyl-containing monomers, amino-containing monomers, amido-containing monomers, and heterocycle-containing vinyl monomers; of which acrylic acid (AA), methacrylic acid (MAA), 2-hydroxyethyl acrylate (2HEA), 6-hydroxyhexyl acrylate (HHA), 4-hydroxybutyl acrylate (4HBA), N-vinyl-2-pyrrolidone (NVP), and N-hydroxyethylacrylamide (HEAR), for example, are particularly preferred.

The acrylic polymer may contain a polar-group-containing monomer(s) in a content of preferably 40 percent by weight or less (e.g., from 0.01 to 40 percent by weight), and more preferably from 1 to 30 percent by weight, based on the total amount of monomer components for the formation of the acrylic polymer. If the content is more than 40 percent by weight, for example, the pressure-sensitive adhesive layer may have an excessively high cohesive strength and may have insufficient stress relaxation property. If the content is excessively small of less than 0.01 percent by weight, the pressure-sensitive adhesive layer may have a reduced cohesive strength to thereby have insufficient adhesive performance.

Exemplary multifunctional monomers include hexanediol di(meth)acrylate, butanediol di(meth)acrylate, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, allyl (meth)acrylate, vinyl (meth)acrylate, divinylbenzene, epoxy acrylates, polyester acrylates, and urethane acrylates. Each of such multifunctional monomers may be used alone or in combination.

The acrylic polymer may contain a multifunctional monomer(s) in a content of 5 percent by weight or less (e.g., from 0.001 to 5 percent by weight), based on the total amount of monomer components for the formation of the acrylic polymer. If the content is more than 5 percent by weight, the pressure-sensitive adhesive layer may have an excessively high cohesive strength to thereby have insufficient stress relaxation property.

Exemplary other copolymerizable monomers (additional copolymerizable monomers) than the polar-group-containing monomers and multifunctional monomers include (meth)acrylic esters other than the alkyl (meth)acrylates, polar-group-containing monomers, and multifunctional monomers, including (meth)acrylic esters having an alicyclic hydrocarbon group, such as cyclopentyl (meth)acrylate, cyclohexyl (meth)acrylate, and isobornyl (meth)acrylate, as well as (meth)acrylic esters having an aromatic hydrocarbon group, such as phenyl (meth)acrylate; vinyl esters such as vinyl acetate and vinyl propionate; aromatic vinyl compounds such as styrene and vinyltoluene; olefins or dienes such as ethylene, butadiene, isoprene, and isobutylene; vinyl ethers such as vinyl alkyl ethers; and vinyl chloride.

An acrylic polymer as a base polymer may be prepared by polymerizing the monomer component(s) by a known or customary polymerization process. Exemplary polymerization processes of such acrylic polymers include solution polymerization processes, emulsion polymerization processes, bulk polymerization processes, and polymerization processes through the irradiation with an active energy ray (active energy ray polymerization processes, photopolymerization processes). Among them, solution polymerization processes and active energy ray polymerization processes are preferred from the points typically of optical transparency, water resistance, and cost. Particularly for the formation of a relatively thick pressure-sensitive adhesive layer, active energy ray polymerization processes are preferred, of which an ultraviolet-initiated polymerization process through ultraviolet irradiation is more preferred.

Exemplary active energy rays to be applied upon active energy ray polymerization (photopolymerization) include ionizing radiation such as alpha rays, beta rays, gamma rays, neutron beams, and electron beams; and ultraviolet rays, of which ultraviolet rays are preferred. Conditions of active energy ray irradiation, such as irradiation energy, irradiation time, and irradiation process, are not limited, as long as a photoinitiator is activated to cause a reaction of a monomer component.

Various common solvents may be used upon solution polymerization. Examples of such solvents include organic solvents including esters such as ethyl acetate and n-butyl acetate; aromatic hydrocarbons such as toluene and benzene; aliphatic hydrocarbons such as n-hexane and n-heptane; alicyclic hydrocarbons such as cyclohexane and methylcyclohexane; and ketones such as methyl ethyl ketone and methyl isobutyl ketone. Each of different solvents may be used alone or in combination.

Upon the preparation of the acrylic polymer, a polymerization initiator, such as a thermal initiator or a photopolymerization initiator (photoinitiator), may be used depending on the type of the polymerization reaction. Each of different polymerization initiators may be used alone or in combination.

Examples of the photoinitiator usable herein include, but are not limited to, benzoin ether photoinitiators, acetophenone photoinitiators, α-ketol photoinitiators, aromatic sulfonyl chloride photoinitiators, photoactive oxime photoinitiators, benzoin photoinitiators, benzil photoinitiators, benzophenone photoinitiators, ketal photoinitiators, and thioxanthone photoinitiators.

Examples of the benzoin ether photoinitiators include benzoin methyl ether, benzoin ethyl ether, benzoin propyl ether, benzoin isopropyl ether, benzoin isobutyl ether, 2,2-dimethoxy-1,2-diphenylethan-1-one, and anisole methyl ether. Exemplary acetophenone photoinitiators include 2,2-diethoxyacetophenone, 2,2-dimethoxy-2-phenylacetophenone, 1-hydroxycyclohexyl phenyl ketone, 4-phenoxydichloroacetophenone, and 4-(t-butyl) dichloroacetophenone. Exemplary α-ketol photoinitiators include 2-methyl-2-hydroxypropiophenone and 1-[4-(2-hydroxyethyl)phenyl]-2-methylpropan-1-one. Exemplary aromatic sulfonyl chloride photoinitiators include 2-naphthalenesulfonyl chloride. Exemplary photoactive oxime photoinitiators include 1-phenyl-1,1-propanedione-2-(o-ethoxycarbonyl)-oxime. Exemplary benzoin photoinitiators include benzoin. Exemplary benzil photoinitiators include benzil. Exemplary benzophenone photoinitiators include benzophenone, benzoylbenzoic acid, 3,3′-dimethyl-4-methoxybenzophenone, polyvinylbenzophenones, and α-hydroxycyclohexyl phenyl ketone. Examples of the ketal photoinitiators include benzyl dimethyl ketal. Exemplary thioxanthone photoinitiators include thioxanthone, 2-chlorothioxanthone, 2-methylthioxanthone, 2,4-dimethylthioxanthone, isopropylthioxanthone, 2,4-diisopropylthioxanthone, and dodecylthioxanthone.

Though not critical, the photoinitiator(s) may be used in an amount of preferably from 0.005 to 1 part by weight, per 100 parts by weight of the total amount of monomer components for the formation of the acrylic polymer. Each of different photoinitiators may be used alone or in combination.

Exemplary thermal initiators include azo polymerization initiators [e.g., 2,2′-azobisisobutyronitrile, 2,2′-azobis-2-methylbutyronitrile, dimethyl 2,2′-azobis(2-methylpropionate), 4,4′-azobis-4-cyanovaleric acid, azobisisovaleronitrile, 2,2′-azobis(2-amidinopropane) dihydrochloride, 2,2′-azobis[2-(5-methyl-2-imidazolin-2-yl)propane]dihydrochloride, 2,2′-azobis(2-methylpropionamidine) disulfate, and 2,2′-azobis(N,N′-dimethyleneisobutylamidine) dihydrochloride]; peroxide polymerization initiators (e.g., dibenzoyl peroxide and tert-butyl permaleate); and redox polymerization initiators. Such a thermal initiator(s) may be used in an amount not critical, as long as falling within a customary range as to be usable as a thermal initiator.

The pressure-sensitive adhesive layer of the pressure-sensitive adhesive sheet for optical use may employ a crosslinking agent. The use of a crosslinking agent allows the acrylic polymer to be crosslinked and thereby allows the pressure-sensitive adhesive layer to have a further higher cohesive strength. Though not limited, customarily known crosslinking agents may be widely used as the crosslinking agent, of which isocyanate crosslinking agents and epoxy crosslinking agents are advantageously usable. Each of different crosslinking agents may be used alone or in combination.

The isocyanate crosslinking agents include lower aliphatic polyisocyanates such as 1,2-ethylene diisocyanate, 1,4-butylene diisocyanate, and 1,6-hexamethylene diisocyanate; alicyclic polyisocyanates such as cyclopentylene diisocyanate, cyclohexylene diisocyanate, isophorone diisocyanate, hydrogenated tolylene diisocyanate, and hydrogenated xylene diisocyanate; and aromatic polyisocyanates such as 2,4-tolylene diisocyanate, 2,6-tolylene diisocyanate, 4,4′-diphenylmethane diisocyanate, and xylylene diisocyanate. Exemplary isocyanate crosslinking agents usable herein further include a trimethylolpropane/tolylene diisocyanate adduct [supplied by Nippon Polyurethane Industry Co., Ltd. under the trade name “CORONATE L”] and a trimethylolpropane/hexamethylene diisocyanate adduct [supplied by Nippon Polyurethane Industry Co., Ltd. under the trade name “CORONATE HL”].

Examples of the epoxy crosslinking agents include N,N,N′,N′-tetraglycidyl-m-xylenediamine, diglycidylaniline, 1,3-bis(N,N-diglycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ethers, polypropylene glycol diglycidyl ethers, sorbitol polyglycidyl ethers, glycerol polyglycidyl ethers, pentaerythritol polyglycidyl ethers, polyglycerol polyglycidyl ethers, sorbitan polyglycidyl ethers, trimethylolpropane polyglycidyl ethers, diglycidyl adipate, o-diglycidyl phthalate, triglycidyl-tris(2-hydroxyethyl) isocyanurate, resorcinol diglycidyl ether, bisphenol-S-diglycidyl ether; as well as epoxy resins having two or more epoxy groups per molecule. Exemplary commercially available products of them include a product supplied by Mitsubishi Gas Chemical Company, Inc. under the trade name “TETRAD C.”

Though not critical, the crosslinking agent(s) may be used in an amount of generally preferably from 0.001 to 20 parts by weight, and more preferably from 0.01 to 10 parts by weight, typically per 100 parts by weight of the acrylic polymer. Among others, an isocyanate crosslinking agent(s), when used, may be used in an amount of preferably from 0.01 to 20 parts by weight, and more preferably from 0.01 to 3 parts by weight, per 100 parts by weight of the acrylic polymer. An epoxy crosslinking agent(s), when used, may be used in an amount of preferably from 0.001 to 5 parts by weight, and more preferably from 0.01 to 5 parts by weight, per 100 parts by weight of the acrylic polymer.

The pressure-sensitive adhesive layer of the pressure-sensitive adhesive sheet for optical use may further employ known additives according to necessity within ranges not adversely affecting properties obtained by the present invention. Examples of such additives include cross-linking promoters, tackifiers (e.g., rosin derivative resins, polyterpene resins, petroleum resins, and oil-soluble phenol resins), age inhibitors, fillers, colorants (e.g., pigments and dyestuffs), ultraviolet absorbers, antioxidants, chain-transfer agents, plasticizers, softeners, surfactants, and antistatic agents.

The formation process of the pressure-sensitive adhesive layer of the pressure-sensitive adhesive sheet for optical use according to the present invention may employ a known, customary formation process of a pressure-sensitive adhesive layer, which process may vary depending typically on the polymerization process of the base polymer. Exemplary formation processes include, but are not limited to, following processes: (1) a process of coating (applying to) a base or release liner with a composition (pressure-sensitive adhesive composition, active energy ray-curable pressure-sensitive adhesive composition), the composition including a mixture (monomer mixture) of monomer components for the formation of a base polymer (e.g., an acrylic polymer) or a partially polymerized prepolymer thereof, and, according to necessity, additives such as a photoinitiator, and applying an active energy ray thereto to form a pressure-sensitive adhesive layer; and (2) a process of coating (applying to) a base or release liner with a composition (pressure-sensitive adhesive composition, solvent-borne pressure-sensitive adhesive composition) containing a base polymer, a solvent, and, according to necessity, one or more additives, and drying and/or curing the applied coat to form a pressure-sensitive adhesive layer. The processes (1) and (2) may each be provided with a heating/drying step according to necessity. As used herein the term “monomer mixture” refers to a mixture including only monomer component(s) for the formation of a base polymer. Also as used herein the term “partially polymerized prepolymer” refers to a composition in which one or more of components of the monomer mixture have been partially polymerized. As used herein the term “pressure-sensitive adhesive composition” refers to and includes “a composition for the formation of a pressure-sensitive adhesive layer.”

The coating (application) in the formation process of the pressure-sensitive adhesive layer may employ a known coating procedure and may use a customary coater such as gravure roll coater, reverse roll coater, kiss-contact roll coater, dip roll coater, bar coater, knife coater, spray coater, comma coater, or direct coater.

Though not critical, the pressure-sensitive adhesive layer has a thickness of preferably from 5 to 500 μm, and more preferably from 10 to 250 μm.

### (Base)

When the pressure-sensitive adhesive sheet for optical use according to the present invention is of a base-supported type (substrate-supported type), exemplary bases include, but are not limited to, various optical films such as plastic films, anti-reflective (AR) films, deflector plates, and retardation films. Exemplary materials typically for the plastic films include plastic materials including polyester resins such as poly(ethylene terephthalate)s (PETs); acrylic resins such as poly(methyl methacrylate)s (PMMAs); polycarbonates; triacetylcellulose; polysulfones; polyarylates; and cyclic olefinic polymers such as the trade name “ARTON (cyclic olefinic polymer; supplied by JSR)” and the trade name “ZEONOR (cyclic olefinic polymer; supplied by ZEON CORPORATION).” Each of different plastic materials may be used alone or in combination. As used herein the term “base” refers to a portion that is affixed, together with the pressure-sensitive adhesive layer, to an adherend when the pressure-sensitive adhesive sheet for optical use is used (affixed) to the adherend (e.g., optical member). The “base” does not include a release liner (separator) that will be removed upon the use (affixation) of the pressure-sensitive adhesive sheet for optical use.

Of such bases, transparent bases are preferred for providing high optical transparency of the pressure-sensitive adhesive sheet for optical use. As used herein the term “transparent base” refers to a base typically having a total luminous transmittance (in accordance with JIS K 7361) of preferably 85% or more, and more preferably 90% or more at visible light wavelengths. Examples of the transparent base include PET films, and non-oriented films derived from the trade name “ARTON” and from the trade name “ZEONOR.”

Though not critical, the base preferably has a thickness of, for example, from 12 to 50 μm. The base may have either a single-layer structure or a multilayer structure. The base, on its surface, may have been subjected to a known or customary suitable surface treatment, for example, a physical treatment such as corona discharge treatment or plasma treatment, or a chemical treatment such as primer coating.

The base may be an optical member. Specifically, the pressure-sensitive adhesive sheet for optical use according to the present invention may include a pressure-sensitive adhesive layer; and a base composed of an optical member.

### (Release Liner)

The pressure-sensitive adhesive layer surface(s) (adhesive face(s)) of the pressure-sensitive adhesive sheet for optical use according to the present invention may be protected by a release liner (separator) before use. The adhesive faces of the pressure-sensitive adhesive sheet for optical use may be protected by two release liners respectively or may be protected by one release liner having release surfaces as both surfaces while being wound as a roll. The release liner(s) is used as a protective member for the pressure-sensitive adhesive layer(s) and will be removed upon the affixation to an adherend. When the pressure-sensitive adhesive sheet for optical use according to the present invention is a base-less double-coated pressure-sensitive adhesive sheet, the release liner(s) also serves as a support for the pressure-sensitive adhesive layers. Such release liner(s) does not necessarily have to be provided. The release liner(s) may for example be a customary release paper, and examples thereof include bases having a release-treated layer; low-adhesive bases including a fluorocarbon polymer; and low-adhesive bases including a nonpolar polymer. Examples of the bases having a release-treated layer include plastic films and papers having undergone a surface treatment with a release agent such as a silicone, long-chain alkyl, fluorine-containing, or molybdenum sulfide release agent. Exemplary fluorocarbon polymers in the fluorocarbon-polymer-containing low-adhesive bases include polytetrafluoroethylenes, polychlorotrifluoroethylenes, poly(vinyl fluoride)s, poly(vinylidene fluoride)s, tetrafluoroethylene-hexafluoropropylene copolymers, and chlorofluoroethylene-vinylidene fluoride copolymers. Exemplary nonpolar polymers in the nonpolar-polymer-containing low-adhesive bases include olefinic resins (e.g., polyethylenes and polypropylenes). The release liner may be formed by a known or customary process. The thickness and other parameters of the release liner are not critical.

### (Pressure-Sensitive Adhesive Sheet for Optical Use)

The pressure-sensitive adhesive sheet for optical use according to the present invention has a pressure-sensitive adhesive layer which serves as an insulating layer and which less suffers from capacitance change due to changes in signal frequency and in environment (temperature, humidity). The pressure-sensitive adhesive sheet for optical use excels in thickness precision in the pressure-sensitive adhesive layer. In addition, the pressure-sensitive adhesive sheet for optical use excels also in optical transparency.

More specifically, the pressure-sensitive adhesive sheet for optical use according to the present invention is used in applications for bonding an optical member (for optical member bonding) or in applications for manufacturing an optical product.

As used herein the term “optical member” refers to a member having any of optical properties such as polarizability, photorefractivity, light scattering, light reflectivity, optical transparency, optical absorptivity, optical diffractive ability, optical rotatory power, and visibility. Such an optical member is not limited, as long as being a member having any of optical properties, and examples thereof include members constituting, or being used in, devices (optical devices) such as display devices (image display devices) and input devices. Specifically, exemplary optical members include polarizing plates, wave plates, retardation films (phase difference films), compensation films, brightness enhancing films, light-guiding panels, reflective films, antireflective films, transparent electroconductive films (e.g., indium-tin-oxide (ITO) films), films with graphical design function, decorative films, surface-protective films, prisms, lenses, color filters, and transparent substrates; and laminates of these members. As used herein, the terms “plate(s) (or panel(s))” and “film(s)” also include articles in the form typically of plates, films, and sheets, respectively. Typically, the term “polarizing plate(s)” also includes “polarizing film(s)” and “polarizing sheet(s).”

Examples of the display devices include liquid crystal display devices, organic electroluminescent (organic EL) display devices, plasma display panels (PDPs), and electronic papers. Exemplary input devices include touch panels (of which capacitive touch panels, for example, are preferred).

Of these, the pressure-sensitive adhesive sheet for optical use according to the present invention is preferably used typically in applications for bonding a member constituting a capacitive touch panel.

Examples of the optical members include, but are not limited to, members (e.g., members in the form of sheets, films, or plates) including, for example, acrylic resins, polycarbonates, poly(ethylene terephthalate)s, glass, or metal thin films. As used herein the term “optical member” also includes members (e.g., films with graphical design function, decorative films, and surface-protecting films) which play a role of adding graphical design or of protecting while maintaining visibility of a display device or input device as an adherend, as described above.

Exemplary possible embodiments of the bonding of an optical member through the pressure-sensitive adhesive sheet for optical use according to the present invention include, but are not limited to, (1) an embodiment of bonding optical members to each other through the pressure-sensitive adhesive sheet for optical use according to the present invention; (2) an embodiment of bonding an optical member to a member other than optical member through the pressure-sensitive adhesive sheet for optical use according to the present invention; and (3) an embodiment of bonding the pressure-sensitive adhesive sheet for optical use according to the present invention including an optical member to an optical member or to a member other than optical member. In the embodiment (3), the pressure-sensitive adhesive sheet for optical use according to the present invention is preferably a pressure-sensitive adhesive sheet for optical use having, as a base, an optical member (e.g., a polarizing film or another optical film).

By affixing or laminating the pressure-sensitive adhesive sheet for optical use according to the present invention onto a surface (at least one surface) of an optical member, there is provided a pressure-sensitive optical member including the optical member and, on at least one side thereof, a pressure-sensitive adhesive layer (preferably the pressure-sensitive adhesive layer for use in the present invention).

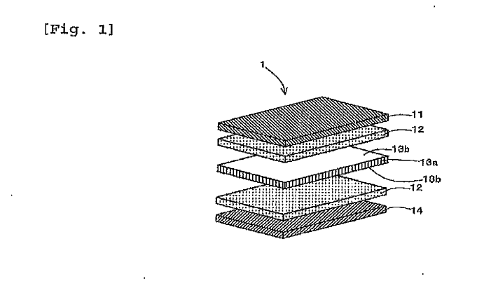

As a more specific example, FIG. 1 depicts a schematic diagram of an exemplary capacitive touch panel including members having been bonded through the pressure-sensitive adhesive sheet for optical use according to the present invention. In FIG. 1, the reference signs “1” stands for a capacitive touch panel, “11” stands for a transparent protective lens, “12” stands for a pressure-sensitive adhesive sheet for optical use, “13a” stands for an ITO glass substrate, “13b” stands for an ITO film (transparent electroconductive film), and “14” stands for a liquid crystal display. In the capacitive touch panel 1, the “transparent protective lens 11” is bonded to the “ITO glass substrate 13a provided with the ITO films 13b on both sides thereof” through the pressure-sensitive adhesive sheet 12 for optical use; and the “ITO glass substrate 13a provided with ITO films 13b on both sides thereof” is bonded to the “liquid crystal display 14” through another ply of the pressure-sensitive adhesive sheet 12 for optical use. The capacitive touch panel 1 herein employs the ITO glass substrate 13a provided with ITO films 13b on both sides thereof. In general, however, such a capacitive touch panel may employ an ITO glass substrate provided with an ITO film on one side thereof.

Such a capacitive touch panel as mentioned above has a pressure-sensitive adhesive layer formed from the pressure-sensitive adhesive sheet for optical use and serving as an insulating layer, where the pressure-sensitive adhesive layer less suffers from capacitance change due to changes in signal frequency and in environment (temperature, humidity), is stable. The capacitive touch panel thereby has high sensitivity and satisfactory operational stability. In addition, the capacitive touch panel also excels in visibility due to high optical transparency of the pressure-sensitive adhesive sheet for optical use.

### (Optical Device)

In accordance with the present invention, an optical device uses the pressure-sensitive adhesive sheet for optical use. In the optical device, the pressure-sensitive adhesive sheet for optical use is used typically for bonding a member constituting the optical device or for bonding a member for use in the device. The resulting optical device, as using the pressure-sensitive adhesive sheet for optical use, has good sensitivity, satisfactory operational stability, and excellent visibility.

Exemplary optical devices include display devices (image display devices) such as liquid crystal display devices, organic EL (electroluminescent) display devices, PDPs (plasma display panels), and electronic papers; and input devices such as touch panels (of which capacitive touch panels are preferred).

### EXAMPLES

The present invention will be illustrated in further detail with reference to several working examples below. It should be noted, however, that these examples are never construed to limit the scope of the present invention.

### Example 1

### (Preparation of Photopolymerizable Composition)

A partially polymerized prepolymer (monomer syrup) having a degree of polymerization of 10% was prepared by charging, into a four-necked flask, 40 parts by weight of 2-ethylhexyl acrylate, 59 parts by weight of 2-methoxyethyl acrylate, 1 part by weight of 4-hydroxybutyl acrylate, 0.05 part by weight of 2,2-dimethoxy-1,2-diphenyletane-1-one (trade name “IRGACURE 651” supplied by Ciba Japan), and 0.05 part by weight of 1-hydroxy-cyclohexyl-phenyl-ketone (trade name “IRGACURE 184” supplied by Ciba Japan); and partially photopolymerizing them through exposure to an ultraviolet ray in a nitrogen atmosphere.

A photopolymerizable composition was then prepared by adding, to 100 parts by weight of the partially polymerized prepolymer, an isocyanate compound (trade name “CORONATE L”, supplied by Nippon Polyurethane Industry Co., Ltd., having a solids content of 75 percent by weight) in an amount in terms of solids content of 0.1 part by weight, and mixing them uniformly.

### (Production of Pressure-Sensitive Adhesive Sheet)

The photopolymerizable composition was applied to a thickness of 150 μm to the release-treated surface of a 75-μm thick polyester film, which had been treated with a silicone release agent on one surface thereof, to form a coat layer. The release-treated surface of a 38-μm thick polyester film, which had been treated with a silicone release agent on one surface thereof, was laminated on the coat layer, and a black-light lamp applied an ultraviolet ray from above the surface of the 38-μm thick polyester film, where the lamp height had been adjusted so that the irradiated surface directly below the lamp be irradiated at an intensity of 5 mW/cm². Polymerization was performed until the ultraviolet ray was applied to the amount of light of 3600 mJ/cm², and thereby a 150-μm thick acrylic pressure-sensitive adhesive sheet was produced.

### Example 2

### (Preparation of Photopolymerizable Composition)

A partially polymerized prepolymer (monomer syrup) having a degree of polymerization of 10% was prepared by charging, into a four-necked flask, 69 parts by weight of 2-ethylhexyl acrylate, 30 parts by weight of 2-methoxyethyl acrylate, 1 part by weight of 4-hydroxybutyl acrylate, 3 parts by weight of acrylic acid, 0.05 part by weight of 2,2-dimethoxy-1,2-diphenyl-1-one (trade name “IRGACURE 651” supplied by Ciba Japan), and 0.05 part by weight of 1-hydroxy-cyclohexyl-phenyl-ketone (trade name “IRGACURE 184” supplied by Ciba Japan), and partially photopolymerizing them through exposure to an ultraviolet ray in a nitrogen atmosphere.

A photopolymerizable composition was prepared by adding, to 100 parts by weight of the partially polymerized prepolymer, 0.01 part by weight of trimethylolpropane triacrylate, and mixing them uniformly.

### (Production of Pressure-Sensitive Adhesive Sheet)

The photopolymerizable composition was applied to a thickness of 150 μm to the release-treated surface of a 75-μm thick polyester film, which had been treated with a silicone release agent on one surface thereof, to form a coat layer. The release-treated surface of a 38-μm thick polyester film, which had been treated with a silicone release agent on one surface thereof, was laminated on the coat layer, and a black-light lamp applied an ultraviolet ray from above the surface of the 38-μm thick polyester film, where the lamp height had been adjusted so that the irradiated surface directly below the lamp be irradiated at an intensity of 5 mW/cm². Polymerization was performed until the ultraviolet ray was applied to the amount of light of 3600 mJ/cm², and thereby a 150-μm thick acrylic pressure-sensitive adhesive sheet was produced.

### Example 3

### (Preparation of Photopolymerizable Composition)

A partially polymerized prepolymer (monomer syrup) having a degree of polymerization of 10% was prepared by charging, into a four-necked flask, 68 parts by weight of 2-ethylhexyl acrylate, 24 parts by weight of 2-methoxyethyl acrylate, 6 parts by weight of N-vinylpyrrolidone, 2 parts by weight of hydroxyethylacrylamide, 0.05 part by weight of 2,2-dimethoxy-1,2-diphenyl-1-one (trade name “IRGACURE 651” supplied by Ciba Japan), and 0.05 part by weight of 1-hydroxy-cyclohexyl-phenyl-ketone (trade name “IRGACURE 184” supplied by Ciba Japan), and partially photopolymerizing them through exposure to an ultraviolet ray in a nitrogen atmosphere.

A photopolymerizable composition was prepared by adding, to 100 parts by weight of the partially polymerized prepolymer, 0.015 part by weight of trimethylolpropane triacrylate, and mixing them uniformly.

### (Production of Pressure-Sensitive Adhesive Sheet)

The photopolymerizable composition was applied to a thickness of 150 μm to the release-treated surface of a 75-μm thick polyester film, which had been treated with a silicone release agent on one surface thereof, to form a coat layer. The release-treated surface of a 38-μm thick polyester film, which had been treated with a silicone release agent on one surface thereof, was laminated on the coat layer, and a black-light lamp applied an ultraviolet ray from above the surface of the 38-μm thick polyester film, where the lamp height had been adjusted so that the irradiated surface directly below the lamp be irradiated at an intensity of 5 mW/cm². Polymerization was performed until the ultraviolet ray was applied to the amount of light of 3600 mJ/cm², and thereby a 150-μm thick acrylic pressure-sensitive adhesive sheet was produced.

### Example 4

### (Preparation of Photopolymerizable Composition)

A partially polymerized prepolymer (monomer syrup) having a degree of polymerization of 10% was prepared by charging, into a four-necked flask, 70 parts by weight of 2-ethylhexyl acrylate, 26 parts by weight of N-vinylpyrrolidone, 4 parts by weight of hydroxyethylacrylamide, 0.05 part by weight of 2,2-dimethoxy-1,2-diphenyl-1-one (trade name “IRGACURE 651” supplied by Ciba Japan), and 0.05 part by weight of 1-hydroxy-cyclohexyl-phenyl-ketone (trade name “IRGACURE 184” supplied by Ciba Japan), and partially photopolymerizing them through exposure to an ultraviolet ray in a nitrogen atmosphere.

A photopolymerizable composition was prepared by adding, to 100 parts by weight of the partially polymerized prepolymer, 0.015 part by weight of trimethylolpropane triacrylate, and mixing them uniformly.

### (Production of Pressure-Sensitive Adhesive Sheet)

The photopolymerizable composition was applied to a thickness of 180 μm to the release-treated surface of a 75-μm thick polyester film, which had been treated with a silicone release agent on one surface thereof, to form a coat layer. The release-treated surface of a 38-μm thick polyester film, which had been treated with a silicone release agent on one surface thereof, was laminated on the coat layer, and a black-light lamp applied an ultraviolet ray from above the surface of the 38-μm thick polyester film, where the lamp height had been adjusted so that the irradiated surface directly below the lamp be irradiated at an intensity of 5 mW/cm². Polymerization was performed until the ultraviolet ray was applied to the amount of light of 3600 mJ/cm², and thereby a 180-μm thick acrylic pressure-sensitive adhesive sheet was produced.

### Example 5

An acrylic polymer solution was prepared by charging, into a four-necked flask, 28 parts by weight of 2-ethylhexyl acrylate, 64 parts by weight of ethyl acrylate, 5 parts by weight of methyl methacrylate, 0.4 part by weight of azobisisobutyronitrile, and 100 parts by weight of ethyl acetate, and reacting them at about 60° C. in a nitrogen atmosphere. The acrylic polymer solution was combined with an isocyanate compound (trade name “CORONATE L”, supplied by Nippon Polyurethane Industry Co., Ltd., having a solids content of 75 percent by weight) in an amount in terms of solids content of 1 part by weight. This was applied to the release-treated surface of a 50-μm thick polyester film, which had been treated with a silicone release agent on one surface thereof, dried by heating, and laminated thereon (on the coat layer), the release-treated surface of a 38-μm thick polyester film, which had been treated with a silicone release agent on one surface thereof. Thus, a 30-μm thick acrylic pressure-sensitive adhesive sheet was prepared.

### (Evaluations)

The examples and comparative example were subjected to measurements typically of dielectric constant (relative), dielectric loss tangent, thickness precision, and transmittance. The measurement results are indicated in Table 1.

### (Dielectric Constant(Relative), Dielectric Loss Tangent)

Dielectric constant (relative) at a frequency of 1.0×10⁶ Hz, dielectric constant (relative) at a frequency of 1.0×10⁴ Hz, dielectric loss tangent at a frequency of 1.0×10⁶ Hz, and dielectric loss tangent at a frequency of 1.0×10⁴ Hz were measured in accordance with JIS K 6911 under the following conditions.

Measuring process: capacitance method (apparatus: Agilent Technologies 4294A Precision Impedance Analyzer was used)

Electrode structure: aluminum plate 12.1 mm in diameter and 0.5 mm in thickness

Counter Electrode: 3 oz copper plate

Measuring environment: 23±1° C., 52±1% relative humidity

In Table 1, [A] represents the dielectric constant (relative) at a frequency of 1.0×10⁶ Hz; [B] represents the dielectric constant (relative) at a frequency of 1.0×10⁴ Hz; [C] represents the dielectric loss tangent at a frequency of 1.0×10⁶ Hz; and [D] represents the dielectric loss tangent at a frequency of 1.0×10⁴ Hz.

From the measured value of dielectric constant (relative) at a frequency of 1.0×10⁶ Hz and the measured value of dielectric constant (relative) at a frequency of 1.0×10⁴ Hz, a percentage (%) of the dielectric constant (relative) at a frequency of 1.0×10⁶ Hz was determined according to the following expression, provided that the dielectric constant (relative) at a frequency of 1.0×10⁴ Hz be 100%.

(Dielectric constant (relative) at a frequency of 1.0×10⁶ Hz)/(Dielectric constant (relative) at a frequency of 1.0×10⁴ Hz)×100

The determined percentage (%) of the dielectric constant (relative) at a frequency of 1.0×10⁶ Hz, provided that the dielectric constant (relative) at a frequency of 1.0×10⁴ Hz be 100%, was indicated in the column “[A]/[B]” in Table 1.

In addition, from the measured value of dielectric loss tangent at a frequency of 1.0×10⁶ Hz and the measured value of dielectric loss tangent at a frequency of 1.0×10⁴ Hz, an absolute value of difference between the dielectric loss tangent at a frequency of 1.0×10⁶ Hz and the dielectric loss tangent at a frequency of 1.0×10⁴ Hz was determined.

The determined absolute value of the difference between the dielectric loss tangent at a frequency of 1.0×10⁶ Hz and the dielectric loss tangent at a frequency of 1.0×10⁴ Hz was indicated in the column “[C]-[D]” in Table 1.

### (Thickness Precision)

The thickness precision was determined in the following manner. Five measurement points were defined in a longitudinal direction within an area of 50 mm wide and 75 mm long, and a thickness at each measurement point was measured using a dial gauge with 1/1000 graduations. A value was determined by dividing a difference between a largest thickness and the target thickness by the target thickness and expressing the result in percentage (see following Expression (1)); and another value was determined by dividing a difference between a smallest thickness and the target thickness by the target thickness and expressing the result in percentage (see following Expression (2)). Then, the absolute value of the former and the absolute value of the latter were compared to each other, and a larger one was defined as a thickness precision (%).

[(Largest thickness)−(Target thickness)]/(Target thickness)×100 (1)

[(Smallest thickness)−(Target thickness)]/(Target thickness)×100 (2)

### (Visible-Light Transmittance)

This was measured using a hazemeter (device name “HM-150” supplied by Murakami Color Research Laboratory).

TABLE 1

| | Dielectric constant | | | Dielectric loss | | | Thickness | Visible-light | |
|---|---|---|---|---|---|---|---|---|---|
| | (relative) | | | tangent | | | precision | transmittance | |
| | [A] | [B] | [A]/[B] | [C] | [D] | [C] − [D] | (%) | (%) | Haze |
| Example 1 | 5.96 | 6.56 | 91 | 0.086 | 0.005 | 0.081 | 5 | 92 | 0.6 |
| Example 2 | 4.65 | 5.36 | 87 | 0.101 | 0.011 | 0.090 | 5 | 92 | 0.6 |
| Example 3 | 4.30 | 5.87 | 73 | 0.116 | 0.082 | 0.034 | 5 | 92 | 0.6 |
| Example 4 | 3.16 | 4.00 | 79 | 0.065 | 0.117 | 0.052 | 5 | 92 | 0.6 |
| Example 5 | 4.17 | 5.34 | 78 | 0.102 | 0.040 | 0.062 | 4 | 92 | 0.5 |

Capacitive touch panels as illustrated in FIG. 1 were produced by using the examples. The resulting capacitive touch panels using the examples excelled in sensing sensitivity and stability and did not suffer from a misoperation.

### INDUSTRIAL APPLICABILITY

Pressure-sensitive adhesive sheets for optical use according to the present invention are used in applications for bonding an optical member (for optical member bonding) and in applications for manufacturing an optical product. The pressure-sensitive adhesive sheets are particularly preferably used typically in applications for bonding a member constituting a capacitive touch panel.

### REFERENCE SIGNS LIST

1 capacitive touch panel
11 transparent protective lens
12 pressure-sensitive adhesive sheet for optical use
13a ITO glass substrate
13b ITO film
14 liquid crystal display

1. A pressure-sensitive adhesive sheet for optical use comprising a pressure-sensitive adhesive layer, the pressure-sensitive adhesive sheet having a dielectric constant (relative) of from 2 to 8 at a frequency of 1 MHz and a dielectric loss tangent of more than 0 and 0.2 or less at a frequency of 1 MHz,
wherein the pressure-sensitive adhesive layer is an acrylic pressure-sensitive adhesive layer;
wherein the acrylic pressure-sensitive adhesive layer comprises, as a base polymer, an acrylic polymer derived from an acrylic monomer as an essential monomer component and a polar-group-containing monomer as a copolymerizable monomer component;
wherein the essential monomer component is an alkyl (meth)acrylate alone or in combination with an alkoxyalkyl (meth)acrylate, the alkyl (meth)acrylate having a linear or branched chain alkyl group containing 1 to 4 carbon atoms;
wherein the polar-group-containing monomer is at least one monomer selected from the group consisting of carboxyl-containing monomers or acid anhydrides of them, hydroxyl-containing monomers, amino-containing monomers, amido-containing monomers, and heterocycle-containing vinyl monomers.

2. The pressure-sensitive adhesive sheet for optical use according to claim 1, wherein the pressure-sensitive adhesive sheet has a dielectric constant (relative) at a frequency of 1.0×10⁶ Hz being 60% or more of a dielectric constant (relative) at a frequency of 1.0×10⁴ Hz.

3. The pressure-sensitive adhesive sheet for optical use according to claim 1, wherein the pressure-sensitive adhesive sheet has an absolute value of difference between a dielectric loss tangent at a frequency of 1.0×10⁶ Hz and a dielectric loss tangent at a frequency of 1.0×10⁴ Hz of 0.15 or less.

4. The pressure-sensitive adhesive sheet for optical use according to claim 1,
wherein the pressure-sensitive adhesive sheet has a thickness precision of 10% or less.

5-6. (canceled)

7. The pressure-sensitive adhesive sheet for optical use according to claim 1, wherein the acrylic pressure-sensitive adhesive layer has been formed from a pressure-sensitive adhesive composition prepared by an ultraviolet-initiated polymerization process through ultraviolet irradiation.

8. The pressure-sensitive adhesive sheet for optical use according to claim 1, for use in bonding of a member constituting a touch panel.

9. The pressure-sensitive adhesive sheet for optical use according to claim 8, wherein the touch panel is of capacitance-operated system.

10. A liquid crystal display device or input device using the pressure-sensitive adhesive sheet for optical use of claim 1.

11. The pressure-sensitive adhesive sheet for optical use according to claim 2, wherein the pressure-sensitive adhesive sheet has an absolute value of difference between a dielectric loss tangent at a frequency of 1.0×10⁶ Hz and a dielectric loss tangent at a frequency of 1.0×10⁴ Hz of 0.15 or less.

12. The pressure-sensitive adhesive sheet for optical use according to claim 2, wherein the pressure-sensitive adhesive sheet has a thickness precision of 10% or less.

13. The pressure-sensitive adhesive sheet for optical use according to claim 3, wherein the pressure-sensitive adhesive sheet has a thickness precision of 10% or less.

14. The pressure-sensitive adhesive sheet for optical use according to claim 2, for use in bonding of a member constituting a touch panel.

15. The pressure-sensitive adhesive sheet for optical use according to claim 3, for use in bonding of a member constituting a touch panel.

16. The pressure-sensitive adhesive sheet for optical use according to claim 4, for use in bonding of a member constituting a touch panel.
